(19) United States
(12) Patent Application Publication
(10) Pub. No.: US 2006/0174545 A1
(43) Pub. Date: Aug. 10, 2006

(54) Banded door sill base and door sill assembly, and method of forming same

(76) Inventor: Robert H. Young, Beaver Dam, KY (US)

Correspondence Address: BERENATO, WHITE & STAVISH, LLC, 6550 ROCK SPRING DRIVE, SUITE 240, BETHESDA, MD, 20817, US

(21) Appl. No.: 11/053,580

(22) Filed: Feb. 9, 2005

(51) Int. Cl. E06B 1/70

(52) U.S. Cl. 49/468

(57) ABSTRACT

The present invention is directed to a banded doorsill base for disposition between a pair of doorjambs of a door frame. The doorsill base includes an elongate central portion formed from a polymeric material having a first coefficient of linear expansion, and first and second wooden strips bonded to and extending along opposite sides of the central portion for constraining the central portion and preventing linear expansion thereof. The first and second strips are formed from a material having a second coefficient of linear expansion less than the first coefficient. The first and second strips substantially prevent linear expansion of the central portion. The present invention also relates to a method of forming the banded doorsill base, and to a doorsill assembly having a banded doorsill base.

### FIELD OF THE INVENTION

The present invention is directed to a banded doorsill base for disposition between a pair of door jambs of a door frame. The doorsill base includes an elongate central portion formed from a polymeric material having a first coefficient of linear expansion, and first and second wooden strips bonded to and extending along opposite sides of the central portion for constraining the central portion and preventing linear expansion thereof. The first and second strips are formed from a material having a second coefficient of linear expansion less than the first coefficient. The first and second strips substantially prevent linear expansion of the central portion. The present invention also relates to a method of forming the banded doorsill base, and to a doorsill assembly having a banded doorsill base.

### BACKGROUND OF THE INVENTION

Doorsill assemblies have been used for many years to seal the bottoms of swinging doors when they are in the closed position. Many sill assemblies include an aluminum threshold member that is secured to a wooden base plate. The assembly is secured to the lower side of a door frame between a pair of door jambs.

Wooden base plates are often used because they are easy to install and relatively inexpensive. In addition, wood has a relatively low thermal conductivity and high dimensional stability. However, wooden base plates are subject to degradation from wood rot. As such, door sill manufacturers have attempted to find an alternative to wooden base plates.

Various attempts to form a door sill base from alternative materials, such as foam plastics, and polymer/wood fiber composites, have been made. However, resinous materials exhibit a relatively high coefficient of linear expansion. The length of a base plate formed from such resinous materials therefore fluctuates as temperature fluctuates. This, in turn, may result in a poor fit between the base plate and the door frame, particularly with door sills having a length of six feet or more. Therefore, non-wooden base plates have not proven practical or cost efficient.

### SUMMARY OF THE INVENTION

The present invention is directed to a banded doorsill base for disposition between a pair of doorjambs of a door frame. The doorsill base includes an elongate central portion, and first and second strips. The central portion is formed from a material having a first coefficient of linear expansion, and has a generally rectangular configuration in plan view with first and second opposite sides and first and second opposite ends. The first strip is attached to and extends along the first side of the central portion. The second strip is attached to and extends along the second side of the central portion. The first and second strips are formed from a material having a second coefficient of linear expansion less than the first coefficient. The first and second strips constrain the central portion and substantially prevent linear expansion of the central portion.

The present invention also relates to a doorsill assembly. The assembly includes a base having ah elongate polymer central portion having a first coefficient of linear expansion. First and second outer strips are secured to opposite longitudinal edges of the central portion. The outer strips are formed from a material having a second coefficient of linear expansion less than the first coefficient. The outer strips constrain the central portion and substantially prevent linear expansion of the central portion. The assembly also includes an elongate threshold member disposed over and connected to the base, and an elongate cover panel connected to and overlying a portion of the base.

A method of forming a banded doorsill base is disclosed. A central portion formed from one of a polymer material and a wood fiber-resin composite and having a first coefficient of linear expansion is provided. A first wood strip is adhesively bonded to a first edge, of the central portion. A second wood strip is adhesively bonded to a second edge of the central portion opposite the first edge. The first and second wood strips have a second coefficient of linear expansion less than the first coefficient so that the first and second wood strips substantially prevent linear expansion of the central portion.

### BRIEF DESCRIPTION OF THE DRAWINGS

FIG. 1 is a perspective view of a banded doorsill base according to an embodiment of the present invention;

FIG. 2 is an elevational view of the banded doorsill base shown in FIG. 1;

FIG. 3 is a cross-sectional view of a doorsill assembly according to a first embodiment;

FIG. 4 is an exploded assembly drawing of the doorsill assembly shown in FIG. 3;

FIG. 5 is a cross-sectional view of a doorsill assembly according to a second embodiment; and

FIG. 6 is a fragmentary exploded assembly drawing of the doorsill assembly shown in FIG. 5.

### DETAILED DESCRIPTION OF THE INVENTION

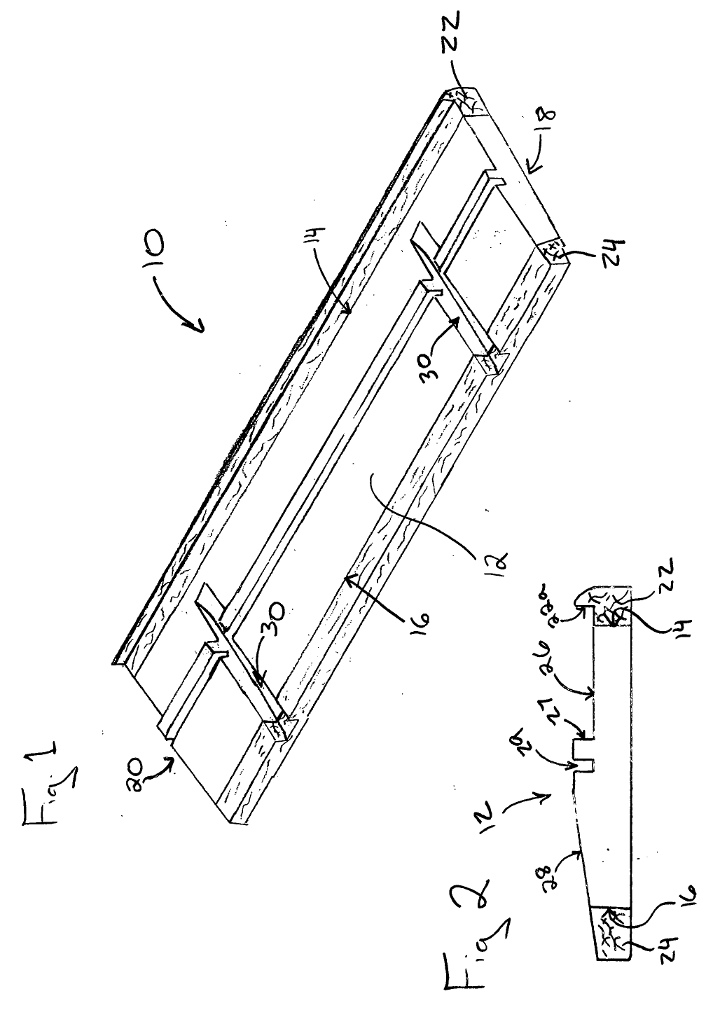

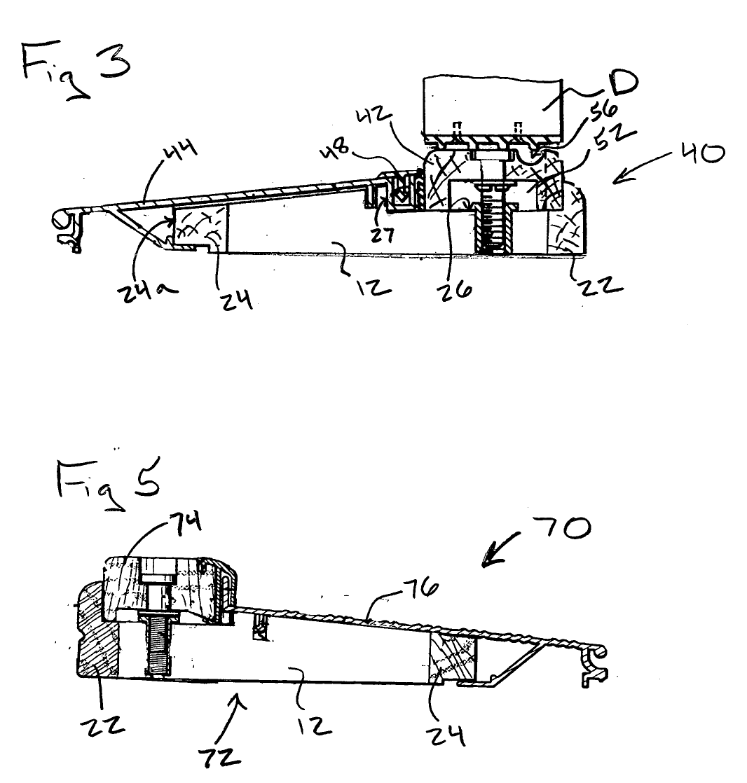

A banded doorsill base 10 according to an embodiment of the present invention is best shown in FIGS. 1 and 2. Base 10 preferably has a suitable length for disposition between a pair of doorjambs of a door frame. Base 10 includes an elongate central portion 12 preferably formed from a polymer material, such as foamed polyvinyl chloride, foamed urethane, and polystyrene. Alternatively, central portion 12 may be formed from a wood fiber-resin composite, such as a polyethylene-wood flour composite.

The material used to form central portion 12 has a known coefficient of linear expansion. The coefficient of linear expansion is defined as the change in length of a substance per change in temperature. Stated mathematically, the coefficient of linear expansion a may be calculated as follows:

$$\frac{Δ L}{{L}_{0}} = α Δ T$$

where ΔL is the change in length, L₀ is the initial length of the object, and ΔT is the change in temperature.

A suitable material for forming central portion 12 will have a coefficient of linear expansion of between about 5×10⁻⁵ in/in/° F. (e.g. urethane foam) and about 1.8×10⁻⁵ in/in/° F. (e.g. wood fiber-resin composite). Generally, as the coefficient of linear expansion increases within this suitable range, the width of central portion 12 should decrease in order to avoid bowing of the ends.

Central portion 12 preferably has a generally rectangular configuration in plan view with first and second opposite sides 14, 16 and first and second opposite ends 18, 20. A first strip 22 is secured to first side 14 and extends from first end 18 to second end 20. A second strip 24 is secured to second side 16 and extends from first end 18 to second end 20. Preferably, first and second strips 22, 24 are adhesively bonded to central portion 12. I have found that a water-curing polyurethane (PUR) adhesive provides a sufficiently strong adhesive bond, though other adhesives may be used, including hot-melt PUR adhesives. A suitable water-curing PUR adhesive is available from National Starch & Chemical Company of Bridgewater, New Jersey under number 82-4000. Alternatively, first and second strips 22, 24 may be mechanically secured to central portion using fasteners, such as screws, nails, pins, or some other suitable fastener.

First and second strips 22, 24 are preferably formed from hardwood, preferably a stain grade hardwood such as oak, but may also be formed from softwood, such as pine. However, hardwood is stronger compared to softwoods and therefore provides additional strength and structural integrity to the resulting banded base 10. In addition, the surface of hardwood has a relatively high bond shear strength compared to softwood, typically about five times greater than the shear strength of softwood. Alternatively, first and second strips 22, 24 may be formed from metal or some other material having a relatively low coefficient of thermal expansion.

The material used to form first and second strips 22, 24 (e.g. hardwood and metal) exhibits minimal expansion due to temperature fluctuations. Strips 22, 24 have a relatively low coefficient of linear expansion, typically about 0.05 to about 0.1 that of the polymer central portion 12. For example, the linear expansion of wood due to normal temperature fluctuations is typically only about 0.1% to 0.2%. First and second strips 22, 24 are secured to central portion 12 and constrain central portion 12 such that linear expansion of central portion 12 is substantially prevented. The adhesive bond or mechanical fastener securing strips 22, 24 to central portion 12 is greater than the force generated by the constrained expansion of central portion 12 due to temperature fluctuations. In this way, strips 22, 24 counterbalance the force generated by the attempted expansion of central portion 12, thereby substantially restraining any such expansion. This, in turn, ensures a good fit of base 10 between door jambs, even with temperatures fluctuations. I have found that strips 22, 24 are required along the opposite sides 14, 16. If only one side is constrained by a wood strip, then the unconstrained side will expand and thereby tend to bow base 10.

Depending on the material used to form central portion 12, central portion 12 may undergo a minimal amount of linear expansion, which creates a slightly bowed appearance to ends 18, 20. However, such expansion is minimal and does not effect the installation and/or fit of base 10 between corresponding doorjambs.

As best shown in FIG. 2, central portion 12 may include an interiorly disposed planar surface 26 adjacent first strip 22 and an exteriorly disposed sloped portion 28 adjacent second strip 24. Planar surface 26 is recessed from sloped portion 28. An interface wall 27 extends between and interconnects planar surface 27 and sloped portion 28. Sloped portion 28 preferably includes a groove 29 spaced from and parallel to interface wall 27. Groove 29 may be configured for receiving a rib on a cover panel of a doorsill assembly. First strip 22 is preferably a shoe strip having an upwardly extending wall 22a relative to planar surface 26.

As best shown in FIG. 1, base 10 may include one or more weep channels 30, which extend downwardly from planar surface 26 through sloped portion 28 and second strip 24. For example, base 10 may include a pair of weep channels 30 proximate opposite ends 18, 20. Weep channels 30 preferably extend substantially perpendicular to second strip 24. The bottom surface of each weep channel may have either a planar configuration, angling downwardly, or an arcuate configuration angling downwardly.

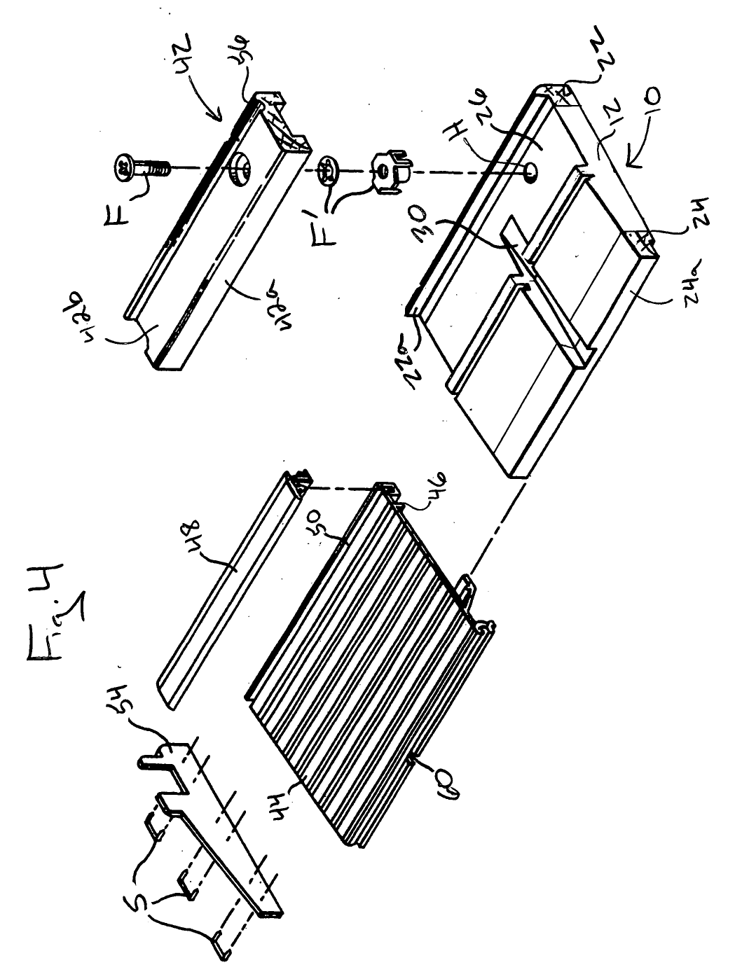

A doorsill assembly 40 according to a first embodiment of the present invention is best shown in FIGS. 3 and 4. Assembly 40 includes an elongated threshold member 42 disposed over and adjustably connected to base 10. Assembly 40 also includes an elongated weather cover panel 44, preferably constructed of an aluminum alloy. Cover panel 44 is attached to base 10 so as to overlie and extend from an exteriorly disposed edge 24a of second strip 24 and interface wall 27. Cover panel 44 may include a rib 46 that is received in groove 29 of base 10. Cover panel 44 forms a foot tread. An elongated gasket 48, preferably a compressible, resilient vinyl gasket, is connected along an interior facing edge portion 50 of cover panel 44, and extends along a narrow gap between interface wall 29 and an exterior facing side 42a of threshold member 42 to inhibit seepage of water therethrough.

A series of conventional, adjustable fasteners F connect threshold member 42 to planar surface 26 of base. Accordingly, planar surface 26 preferably includes a series of holes H for receiving hardware F′ operably associated with fasteners F. Threshold member 42 may be adjustably connected to base 10 so that the upper surface 42b of threshold member 42 conforms to the lower edge of a door D in relatively close fitting relationship when door D is in a closed position in a door frame (not shown).

Threshold member 42 may have an inverted U-shape configuration in section so as to form an elongated, open chamber 52 between threshold member 42 and planar surface 26 of base 10. A pair of compressible, resilient, waterproof end seal gaskets 54, such as closed cell polymer gaskets, may be attached to opposite ends of base using adhesive, although other suitable fastener systems may be used.

Threshold member 42 is thus supported on planar surface 26 between upwardly extending wall 22a of first strip 22 and gasket 48. Threshold member 42 may include an elongated storm drain channel 56 in upper surface 42b thereof, as described in U.S. Pat. No. 5,179,804 to Young, the disclosure of which is incorporated herein by reference. Accordingly, any water that seeps past the weather strip of door D onto upper surface 42b will be collected in storm drain channel 56. The water then migrates toward opposite ends thereof, and downward through end slots in drain channel 56 and onto planar surface 26 of base 10, and thereafter migrates inwardly into a pair of exteriorly extending weep channels 30 formed in base 10. Weep channels 30 may extend downwardly either diagonally or in an arcuate shaped path to discharge water from planar surface 26 out through slots 60 formed in a downwardly extending portion of cover panel 44. In this way, water is expelled from assembly.

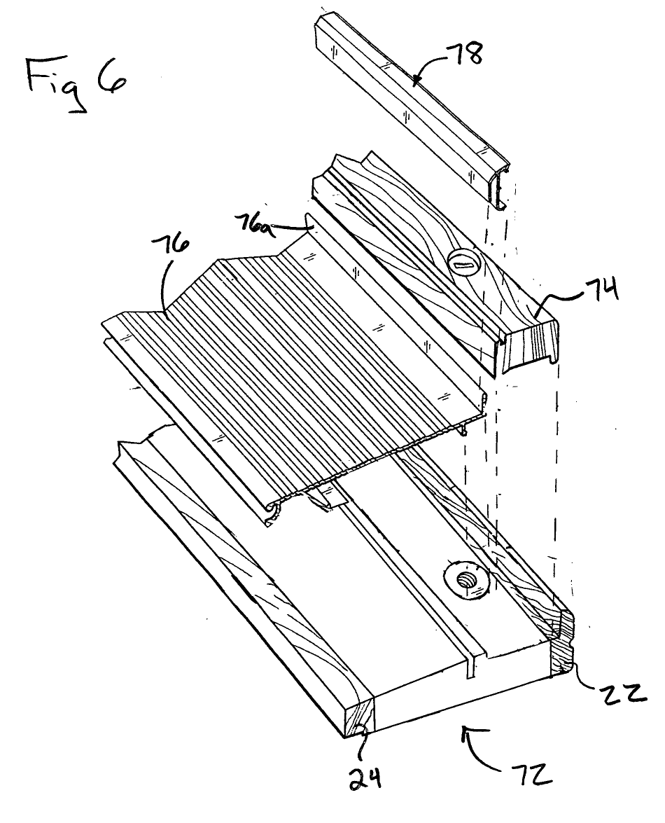

A second embodiment of a doorsill assembly 70 is best shown in FIGS. 5 and 6. Similar to assembly 40, assembly 70 includes a base 72, a threshold member 74, and a cover panel 76. Base 72 is nearly identical to base 10. Accordingly, base includes central portion 12 with first and second strips 22, 24 secured thereto.

Threshold member 74 is similar to threshold member 42, but does not include a storm drain channel. Cover panel 76 has a slightly different configuration compared to cover panel 44, and includes an upwardly extending, interiorly disposed wall 76a which cooperates with a weather strip gasket 78 to seal the gap between cover panel 76 and threshold member 74, such as the weather strip gasket described in U.S. Pat. No. 6,484,446 to Young, the disclosure of which is incorporated herein by reference.

While the disclosed banded doorsill base 10 has been described in terms of various embodiments, it should be understood that base 10 (or 72) may be used for any doorsill assembly. Accordingly, the precise dimensions of central portion 12, and strips 22, 24 may vary depending on the particular threshold member and/or cover panel being used therewith. Furthermore, the precise dimensions of base 10 and associated doorsill assemblies may vary depending on the dimensions of the door frame in which the assembly is being installed.

The present invention is also directed to a method of forming banded doorsill base 10. A rectangular longitudinally extending block of polymer material used to form central portion 12 is provided. Alternatively, a block of wood fiber-resin composite material is provided. The polymer (or composite) block has a generally rectangular configuration. First and second blocks of wood are provided having generally rectangular configurations. The wood blocks are wetted with water, such as by spraying a mist of water thereon. Alternatively, the polymer (or composite) block is wetted. A water-curing PUR adhesive is applied to first and second opposite surfaces of the polymer (or composite) block, and the wood blocks are aligned with and clamped against opposite sides of the polymer (or composite) block. As an alternative to wetting the blocks, the components may be clamped together in an environment sufficiently humid to allow the water-curing PUR to fully cure. Using a water-curing PUR, the components are preferably clamped together for at least about 90 minutes to achieve 50% cure strength.

After the components are cured, the resulting sandwiched block of polymer (or composite) and wood is cut into rectangular sections having a sufficient caliper and length to form banded doorsill base 10. Each rectangular section is then machined to form banded doorsill base 10, with its strips 22, 24, recessed planar surface 26, and interface wall 27 being formed. The base 10 may then be fitted with the cover panel, threshold member, etc.

It will be apparent to one of ordinary skill in the art that various modifications and variations can be made in construction or configuration of the present invention without departing from the scope or spirit of the invention. It is intended that the present invention cover all such modifications and variations, provided they come within the scope of the following claims and their equivalents.

I claim:

1. A banded doorsill base for disposition between a pair of door jambs of a door frame, the doorsill base comprising:
an elongate central portion formed from a material having a first coefficient of linear expansion, said central portion having first and second opposite sides;
a first strip attached to and extending along said first side; and
a second strip attached to and extending along said second side, said first and second strips formed from a material having a second coefficient of linear expansion less than the first coefficient, said first and second strips substantially constraining linear expansion of said central portion.

2. The doorsill base of claim 1, wherein said central portion is formed from a material selected from the group consisting of a polymer and a wood fiber-resin composite.

3. The doorsill base of claim 2, wherein said central portion is formed from polyvinyl chloride.

4. The doorsill base of claim 2, wherein said central portion is formed from a material having a coefficient of linear expansion of between about 1.8×10⁻⁵ in/in/° F. 5×10⁻⁵ in/in/° F.

5. The doorsill base of claim 1, wherein said first and second strips are formed from a material selected from the group consisting of hardwood, softwood, and metal.

6. The doorsill base of claim 1, wherein said central portion includes an interiorly disposed planar surface adjacent said first strip and an exteriorly disposed sloped portion adjacent said second strip.

7. The doorsill base of claim 6, wherein said planar surface is recessed from said sloped portion.

8. The doorsill base of claim 7, wherein said first strip is a shoe strip having an upwardly extending wall relative said planar surface.

9. The doorsill base of claim 7, further comprising at least one weep channel extending downwardly from said planar surface through said sloped portion and through said second strip.

10. The doorsill base of claim 9, wherein said weep channel extends substantially perpendicular to said second strip.

11. The doorsill base of claim 9, wherein said weep channel includes a bottom surface having an arcuate configuration.

12. The doorsill base of claim 1, wherein said first and second strips are adhesively bonded to said central portion.

13. The doorsill base of claim 12, wherein said first and second strips are adhesively bonded to said central portion using one of a water-curing PUR adhesive and a hot-melt PUR adhesive.

14. A doorsill assembly, comprising:
a base having an elongate polymer central portion having a first coefficient of linear expansion and first and second outer strips secured to opposite longitudinal edges of said central portion, said outer strips formed from a material having a second coefficient of linear expansion less than the first coefficient, said outer strips substantially constraining linear expansion of said central portion;
an elongate threshold member disposed over and connected to said base; and
an elongate cover panel connected to and overlying a portion of said base.

15. The doorsill assembly of claim 14, wherein said central portion is formed from a material selected from the group consisting of a polymer and a wood fiber-resin composite.

16. The doorsill assembly of claim 15, wherein said central portion is formed from polyvinyl chloride.

17. The doorsill assembly of claim 14, wherein said first and second outer strips are formed from a material selected from the group consisting of hardwood, softwood, and metal.

18. The doorsill assembly of claim 14, wherein said central portion includes an interiorly disposed planar surface adjacent said first outer strip and an exteriorly disposed sloped portion adjacent said second outer strip.

19. The doorsill assembly of claim 18, wherein said cover panel overlies and extends from said sloped portion to said second outer strip.

20. The doorsill assembly of claim 18, wherein said first outer strip is a shoe strip having an upwardly extending wall relative said planar surface.

21. The doorsill assembly of claim 18, further comprising at least one weep channel extending downwardly from said planar surface through said sloped portion and through said second strip.

22. The doorsill assembly of claim 21, wherein said cover panel includes a slot aligned with said weep channel.

23. The doorsill assembly of claim 22, wherein said threshold member includes a drain channel extending from opposite ends thereof, said threshold member having slots at said opposite ends.

24. The doorsill assembly of claim 14, wherein said first and second outer strips are adhesively bonded to said central portion.

25. A banded doorsill base for disposition between a pair of door jambs of a door frame, the doorsill base comprising:
an elongate central portion formed from a polymeric material having a first coefficient of linear expansion, said central portion having first and second opposite sides;
a first wooden strip attached to and extending along said first side; and
a second wooden strip attached to and extending along said second side, said first and second wooden strips having a second coefficient of linear expansion less than the first coefficient, said first and second wooden strips constraining said central portion and substantially preventing linear expansion thereof.

26. A method of forming a banded doorsill base, comprising the steps of:
providing a central portion formed from one of a polymer material and a wood fiber-resin composite and having a first coefficient of linear expansion;
adhesively bonding a first wood strip to a first edge of the central portion; and
adhesively bonding a second wood strip to a second edge of the central portion opposite the first edge, the first and second wood strips having a second coefficient of linear expansion less than the first coefficient so that the first and second wood strips substantially constrain linear expansion of the central portion.
